(19) United States
(12) Patent Application Publication
(10) Pub. No.: US 2009/0207532 A1
(43) Pub. Date: Aug. 20, 2009

(54) MAGNETO RESISTANCE EFFECT DEVICE, HEAD SLIDER, MAGNETIC INFORMATION STORAGE APPARATUS, AND MAGNETO RESISTANCE EFFECT MEMORY

(75) Inventors: Atsushi Furuya, Kawasaki (JP); Yuji Uehara, Kawasaki (JP); Kenji Noma, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/371,011

(22) Filed: Feb. 13, 2009

(30) Foreign Application Priority Data
Feb. 15, 2008 (JP) 2008-034903

(51) Int. Cl. G11B 5/33

(52) U.S. Cl. 360/324; G9B/5.104

(57) ABSTRACT

A magneto resistance effect device includes a fixed magnetization portion including a ferromagnetic material, in which the magnetization direction can be fixed, and a tunnel barrier layer including high band gap metal oxide and low band gap metal oxide, and arranged on the fixed magnetization portion. The device includes a free magnetization portion including a ferromagnetic material, arranged on the tunnel barrier layer, in which the magnetization can be changed.

### CROSS-REFERENCE TO RELATED APPLICATIONS

This application is based upon and claims the benefit of priority of the prior Japanese Patent Application No. 2008-34903, filed on Feb. 15, 2008, the entire contents of which are incorporated herein by reference.

### FIELD

The embodiments discussed herein are related to a magneto resistance effect device, a head slider, a magnetic information storage apparatus, and a magneto resistance effect memory.

### BACKGROUND

Conventionally, it has been needed to improve the sensing ability of a read device in order to read record bits magnetically recorded in high density and in fine form according to an increase in the capacity of HDD (Hard Disk Drive).

As the read device, there are generally used a multilayer film which has a GMR (Giant Magneto Resistance) effect, a TMR (Tunneling Magneto Resistance) effect, or the like, which is capable of sensing a small change in a magnetic field emanating from the record bit recorded in a magnetic recording medium, and the like. Thus, the read device is capable of accurately reading the magnetic bits recorded in high density. Reference document is Japanese Patent Laid-Open Publication No. 11-97766.

However, the above described conventional read device has a problem that the resistance thereof needs to be reduced in order to further improve the sensing ability.

That is, a TMR film used in the conventional read device is formed by laminating, as illustrated in FIG. 9, an electrode 156a, an antiferromagnetic layer 151, a ferromagnetic layer 152, a magnesium oxide insulating layer 153 and a ferromagnetic layer 154, and an electrode 156b in this order. The resistance against the current flowing through the TMR film is mostly determined by the material of the insulating layer and the thickness thereof. However, the TMR film using magnesium oxide has a resistance per unit area as large as 1 to 10 [Ωμm²], so that the output signal for sensing a change in the magnetic field is reduced. Therefore, it is preferable to reduce the resistance of the read device in order to further improve its sensing ability to accurately read the magnetic bits recorded in high density.

### SUMMARY

According to an aspect of the embodiment, a magneto resistance effect device, a head slider, a magnetic information storage apparatus, and a magneto resistance effect memory include a fixed magnetization portion including a ferromagnetic material, in which the magnetization direction can be fixed; a tunnel barrier layer including high band gap metal oxide and low band gap metal oxide, and arranged on the fixed magnetization portion. They include a free magnetization portion including a ferromagnetic material, arranged on the tunnel barrier layer, and in which the magnetization direction can be changed.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a conceptual diagram illustrating a TMR film structure of a read device according to example 1;

FIG. 2 is a figure illustrating a structure of the read device according to example 1;

FIG. 3 is a figure illustrating an atomic arrangement model of the TMR film according to example 1;

FIG. 4A is a band chart of a metal oxide (ZnO) according to example 1;

FIG. 4B is a band chart of a metal oxide (CdO) according to example 1;

FIG. 4C is a band chart of a metal oxide (MgO) according to example 1;

FIG. 5 is a figure illustrating evaluation values obtained by simulation calculation of conduction characteristics of a giant magneto resistance effect device using each of the metal oxide insulating materials according to example 1;

FIG. 6 is a figure illustrating a structure of MRAM according to example 2;

FIG. 7 is a figure schematically illustrating an internal structure of a hard disk drive apparatus (magnetic reproducing recording apparatus: HDD);

FIG. 8 is a figure illustrating a specific example of a head slider; and

FIG. 9 is a conceptual diagram illustrating a conventional TMR film structure.

### DESCRIPTION OF EMBODIMENTS

Preferred embodiments of the present invention will be explained with reference to accompanying drawings. In the following, an embodiment for implementing a magneto resistance effect device, a head slider, a magnetic information storage apparatus, and a magneto resistance effect memory, will be described with reference to accompanying drawings. One read device according to example 1 will be described as an embodiment for implementing the magneto resistance effect device, and thereafter another example will be described as another embodiment included in the present technique.

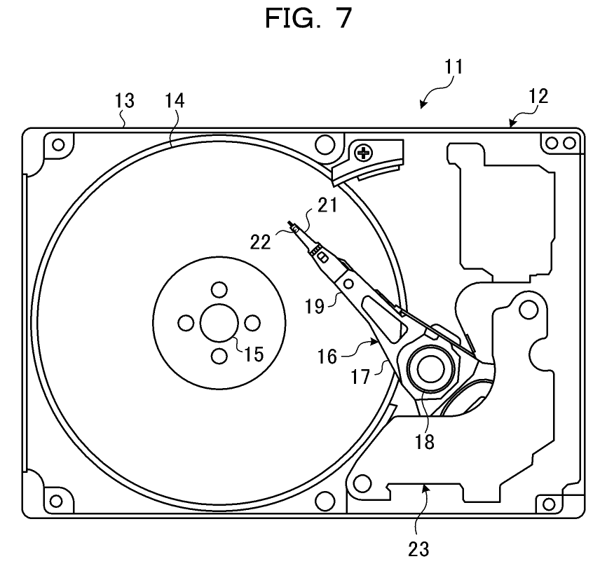

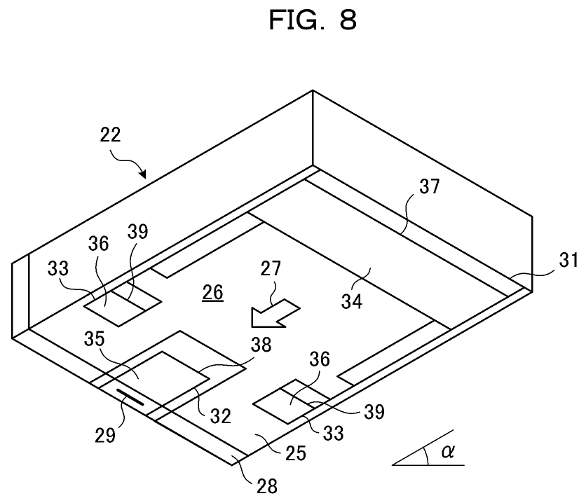

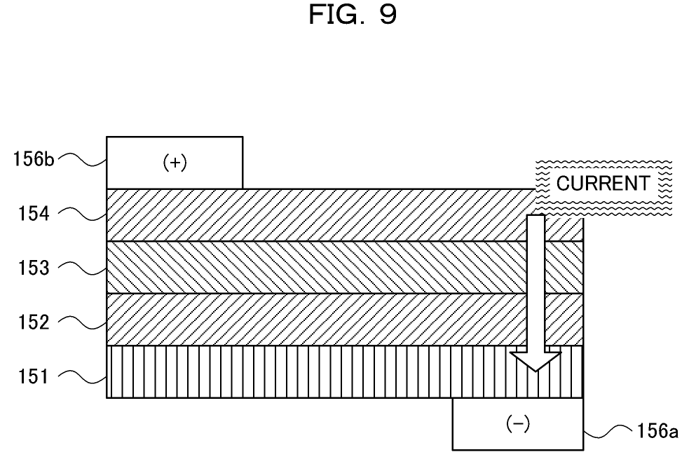

First, with reference to FIG. 7 and FIG. 8, there will be briefly described specific examples of a hard disk drive apparatus (magnetic information storage apparatus: HDD) and a head slider, to which the read device can be applied. FIG. 7 is a figure schematically illustrating an internal structure of the hard disk drive apparatus (magnetic information storage apparatus: HDD). FIG. 8 is a figure illustrating a specific example of the head slider.

As illustrated in FIG. 7, the HDD 11 includes a case, that is, a housing 12. The housing 12 has a box-shaped base 13 and a cover (not illustrated). The base 13 partitions, for example, a flat rectangular inner space, that is, a housing space. The base 13 may be made of a metallic material such as, for example, aluminum by casting. The cover is coupled to the opening of the base 13. The housing space is sealed between the cover and the base 12. The cover may be formed of a sheet of plate material, for example, by press working.

In the housing space, one or more magnetic disks 14 are housed as a storage medium. The magnetic disk 14 is attached to a rotation shaft of a spindle motor 15. The spindle motor 15 is capable of rotating the magnetic disk 14 at a high speed of, for example, 5400 rpm, 7200 rpm, 10000 rpm, 15000 rpm, and the like.

Further, a carriage 16 is housed in the housing space. The carriage 16 includes a carriage block 17. The carriage block 17 is rotatably connected to a support shaft 18 extended in the vertical direction. The carriage block 17 is partitioned by a plurality of carriage arms 19 horizontally extended from the support shaft 18. The carriage block 17 may be formed of aluminum, for example, by extrusion molding.

A head suspension 21 is attached to the distal end of each of the carriage arms 19. The head suspension 21 is extended forward from the distal end of the carriage arm 19. A flexure is stuck to the head suspension 21. A gimbal is partitioned from the flexure at the distal end of the head suspension 21. A floating head slider 22 is mounted to the gimbal. The floating head slider 22 is able to change the posture thereof with respect to the head suspension 21 by the action of the gimbal. A magnetic head, that is, an electromagnetic conversion device is mounted in the floating head slider 22.

When an air flow is generated on the surface of the magnetic disk 14 by the rotation of the magnetic disk 14, a positive pressure, that is, a floating force and a negative pressure act on the floating head slider 22 by the action of the air flow. The floating force and the negative pressure are balanced with the pressing force of the head suspension 21. In this way, the floating head slider 22 with a relatively high rigidity can be continuously floated during the rotation of the magnetic disk 14.

A power source such as, for example, a voice coil motor (VCM) 23, is connected to the carriage block 17. The carriage block 17 can be rotated about the support shaft 18 by the action of the VCM 23. The movement of the carriage arm 19 and the head suspension 21 is realized by the rotation of the carriage block 17. When the carriage arm 19 is rotated about the support shaft 18 during the floating of the floating head slider 22, the floating head slider 22 can traverse the surface of the magnetic disk 14 in the radial direction thereof. As a result, the electromagnetic conversion device on the floating head slider 22 can traverse a data zone between the innermost recording track and the outermost recording track. On the basis of the movement of the floating head slider 22, the electromagnetic conversion device can be positioned at a target recording track.

Further, as illustrated in FIG. 8, the floating head slider 22 includes a base member, that is, a slider main body 25 which is formed into, for example, a flat rectangular solid. The slider main body 25 may be formed of a hard non-magnetic material, such as A1₂O₃—TiC (AlTiC). A medium facing surface, that is, a floating surface 26 of the slider main body 25 faces the magnetic disk 14. On the floating surface 26, a flat base surface, that is, a flat reference surface is defined. When the magnetic disk 14 is rotated, an air flow 27 acts on the floating surface 26 from the front end to the rear end of the slider main body 25.

An insulating non-magnetic film, that is, a device built-in film 28 is laminated on the air outflow side end surface of the slider main body 25. An electromagnetic conversion device 29 is incorporated in the device built-in film 28. The device built-in film 28 is formed of a relatively soft insulating non-magnetic material such as, for example, Al₂O₃ (alumina). The floating head slider 22 is, for example, a femto size slider.

On the floating surface 26, there is formed one front rail 31 which is raised up from the base surface on the upstream side of the air flow 27, that is, on the air inflow side. The front rail 31 is extended along the air inflow end of the base surface in the slider width direction. Similarly, on the floating surface 26, there is formed a rear center rail 32 which is raised up from the base surface on the downstream side of the air flow, that is, on the air outflow side. The rear center rail 32 is arranged at the center position in the slider width direction. The rear center rail 32 is extended to reach the device built-in film 28. Further, a pair of left and right rear side rails 33 and 33 are formed on the floating surface 26. The rear side rail 33 is raised up from the base surface along the side end of the slider main body 25 on the air outflow side. The rear center rail 32 is arranged between the rear side rails 33 and 33.

There are defined so-called air bearing surfaces (ABS) 34, 35, 36 and 36 on the top surfaces of the front rail 31, the rear center rail 32, and the rear side rails 33 and 33. The air inflow ends of the air bearing surfaces 34, 35 and 36 are connected to the top surfaces of the front rail 31, the rear center rail 32, and the rear side rail 33 with level differences 37, 38 and 39. When the air flow 27 is received by the floating surface 26, a relatively large positive pressure, that is, a floating force is generated on the air bearing surfaces 34, 35 and 36 by the action of the level differences 37, 38 and 39. Further, a large negative pressure is generated at the rear of, that is, behind the front rail 31. The floating posture of the floating head slider 23 is established on the basis of the balance between the floating force and the negative pressure.

The electromagnetic conversion device 29 is embedded in the rear center rail 32 on the air outflow side of the air bearing surface 35. The electromagnetic conversion device 29 includes a write device and a read device as will be described below. Note that the form of the floating head slider 22 is not limited to the above described form.

In the following example 1, the outline and features of the read device according to example 1 and the structure of the read device will be described in order, and finally, the effects of example 1 will be described.

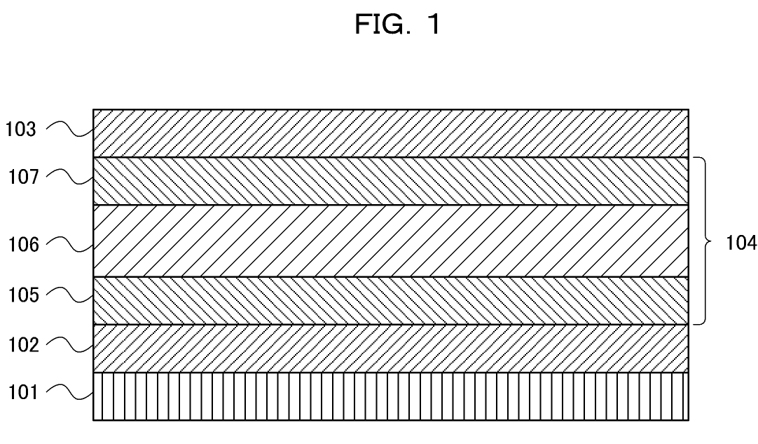

First, the outline and features of the read device according to example 1 will be described with reference to FIG. 1. FIG. 1 is a conceptual diagram illustrating a TMR film structure of a read device according to example 1.

The read device according to example 1 is mainly configured to sense a small change in a magnetic field emanated from a record bit recorded in a magnetic recording medium, or the like, to thereby read the record bits magnetically recorded in high density. Further, the read device according to example 1 is featured in that an insulating layer constituting a TMR film is formed of a high band gap metal oxide and a low band gap metal oxide.

Specifically, as illustrated in FIG. 1, the read element according to example 1 includes an antiferromagnetic layer 101, a ferromagnetic layer 102, an insulating layer 104, and a ferromagnetic layer 103. The insulating layer 104 has a structure formed by arranging a low band gap metal oxide 106 (low band gap oxygen s-electron excitation type metal oxide insulating material) between high band gap metal oxides 105 and 107 (high band gap oxygen s-electron excitation type metal oxide insulating materials).

When the insulating layer 104 is constituted in this way, it is possible to realize reduction in the device resistance of the read device according to example 1.

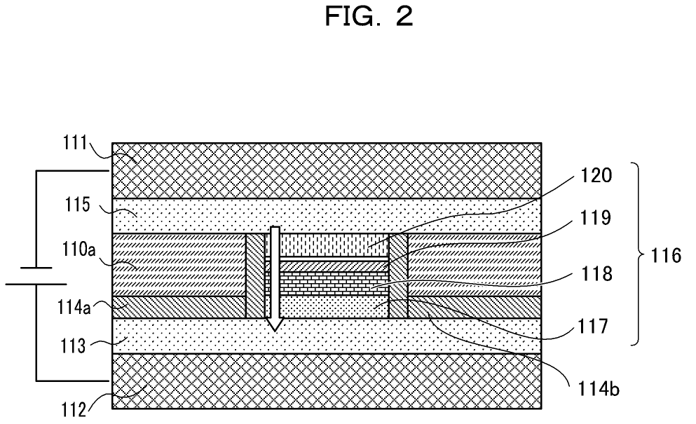

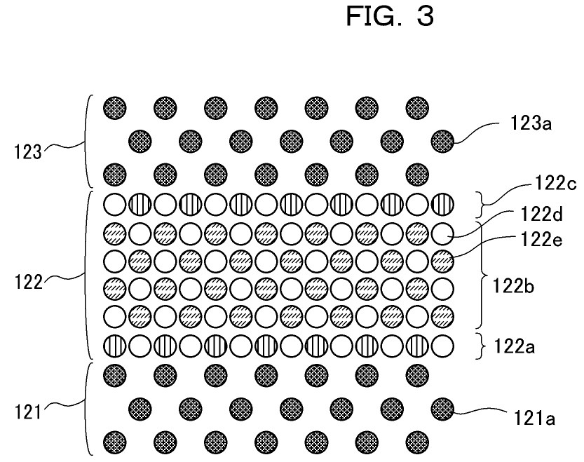

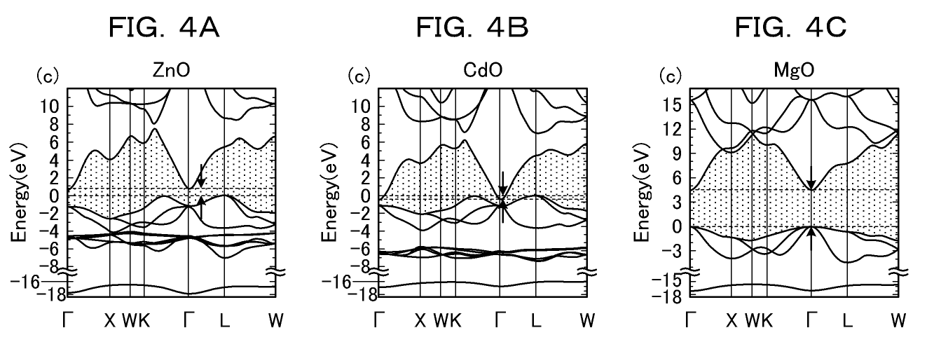

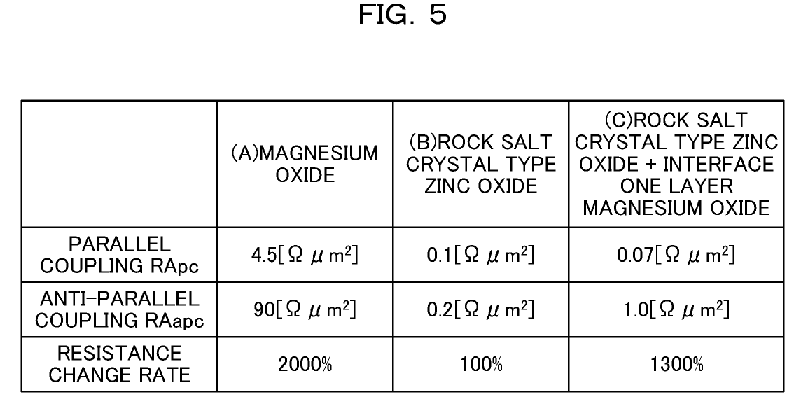

Next, with reference to FIG. 2 to FIG. 5, there will be described a case where the above described read device is applied as a device to read record bits recorded in a hard disk. FIG. 2 is a figure illustrating a structure of the read device according to example 1. FIG. 3 is a figure illustrating an atomic arrangement model of a TMR film according to example 1. FIG. 4A, FIG. 4B and FIG. 4C are band charts of respective metal oxides according to example 1. FIG. 5 is a figure illustrating evaluation values obtained by simulation calculation of conduction characteristics of a giant magneto resistance effect device using each of the metal oxide insulating materials according to example 1.

As illustrated in FIG. 2, the read element according to example 1 includes an upper shield layer 111, a lower shield layer 112, non-magnetic layers 113 and 115, side insulating layers 114a and 114b, and a TMR film 116. The read device according to example 2 is formed so that the TMR film 116 is surrounded by the non-magnetic layers 113 and 115 each of which is formed in contact with each of the lower shield layer 112 and the upper shield layer 111 which are connected to electrodes, and by the side insulating layers 114a and 114b and hard layers (magnetic domain control layers) 110a and 110b. The upper shield layer 111 and the lower shield layer 112 are configured to reduce the magnetic field emanated from the record bits other than the record bit intended to be read.

The TMR film 116 is formed by laminating an antiferromagnetic layer 117, a fixed layer 118, an insulating layer 119, and a free layer 120 in this order. The magnetization direction of the free layer 120 formed of a soft magnetic material is changed by the magnetic field generated by the record bit recorded in the magnetic recording medium.

Each of the free layer 120, the insulating layer 119, and the fixed layer 118 is formed to have a thickness of 0.1 to 20 [nm]. For example, when magnesium oxide is used for the insulating layer 119, it is preferably to set the thickness of the insulating layer to about 1 [nm] in order to set the area resistance per square micron to 10 [Ω] or less.

The amount of current flowing from the free layer 120 to the fixed layer 118 is determined by the amount of tunnel current flowing through the insulating layer having the thickness of about 1 [nm]. Thus, it is possible to evaluate the device resistance and the resistance change rate (magneto resistance effect) of the read device by calculating the amount of tunnel current. The tunnel current means a current which flows through the insulating layer 119 of the TMR film 116 of the read device according to the tunnel effect at the time when a voltage is vertically applied to the TMR film 116.

The current flowing through a very thin layer having a thickness of about 1 [nm] and the resistance of the layer can be calculated by the first principles electronic structure calculation method using an atomic arrangement model of the TMR film (see W. H. Butler, X-G. Zhang, T. C. Schulthess, and J. M. MacLaren, Phys. Rev. B, vol. 63, p. 054 416, 2001).

As illustrated in FIG. 3, the atomic arrangement model of the TMR film according to example 1 includes magnetic layers 121 and 123 which are respectively formed of iron having bcc crystal structures (001 orientation) 121a and 123a, and an insulating layer 122 which is formed of insulators 122a and 122c made of a metal oxide having high band gap characteristics (001 orientation, for example MgO) and which is formed of an insulator 122b made of a metal oxide, for example, including O atom 122d, Zn atom or Cd atom 122e, having low band gap characteristics (001 orientation, for example ZnO,CdO).

Here, the band gap of the metal oxide forming the insulating layer will be described with reference to FIG. 4A, FIG. 4B and FIG. 4C. As a metal oxide which can be used to form the insulating layer, a rock salt crystal type zinc oxide ZnO, a cadmium oxide CdO, a magnesium oxide MgO, and the like, are considered.

As illustrated in FIG. 4A, FIG. 4B and FIG. 4C (portions indicated by arrows), the rock salt crystal type zinc oxide, the cadmium oxide, and the magnesium oxide are featured in that the cadmium oxide has the narrowest band gap, and the magnesium oxide has the largest band gap.

Thus, as illustrated in FIG. 3, the insulating layer based on the atomic arrangement model of the TMR film is formed in such a manner that each of the high band gap insulating layers 122a and 122c using, for example, the magnesium oxide as the high band gap insulator is arranged on the side in contact with each of the magnetic layers, and the low band gap insulator 122b using, for example, the rock salt crystal type zinc oxide as the low band gap insulator is arranged between the high band gap insulating layers 122a and 122c.

Under the simulation condition in which the layer thickness of the high band gap insulating layer in the atomic arrangement model of the TMR film constituted as described above is set to 0.2 [nm], and in which the layer thickness of the low band gap insulating layer is set to 0.8 [nm], the simulation based on the first electronic structure calculation method is performed to evaluate the element resistance and the resistance change rate (magneto resistance effect) of the read device according to example 1. Note that the details of the simulation are derived from the following publication: (see W. H. Butler, X-G. Zhang, T. C. Schulthess, and J. M. MacLaren, Phys. Rev. B, vol. 63, p. 054 416, 2001).

In the following, the evaluation values obtained as the simulation result will be described with reference to FIG. 5. The parallel coupling (pc) as described below indicates the case where the magnetization directions of the free layer and the fixed layer are completely the same direction, while the anti-parallel coupling (apc) indicates the case where the magnetization directions of the free layer and the fixed layer are completely opposite to each other. Then, the area resistance in the parallel coupling state is expressed by RApc, and the area resistance in the anti-parallel coupling state is expressed by RAapc. Note that the resistance change rate as described below is assumed to be calculated in such a way that a value obtained by subtracting RApc from RAapc is divided by RApc.

As illustrated in FIG. 5, in the typical case where the magnesium oxide is used as the insulating layer constituting the TMR film of the read device, the parallel coupling RApc and the anti-parallel coupling RAapc, which represent the area resistance, become 4.5 [Ωm²] and 90 [Ωμm²], respectively, and a resistance change rate (magneto resistance effect) becomes 2000 [%].

Further, as illustrated in FIG. 5, in the case where the rock salt crystal type zinc oxide is used as the insulating layer constituting the TMR film of the read element, the parallel coupling RApc and the anti-parallel coupling RAapc, which represent the area resistance, become 0.1 [Ωμm²] and 0.2 [Ωμm²], respectively, and a resistance change rate becomes 100 [%]. That is, the area resistance can be reduced as compared with the case where the magnesium oxide is used as the insulating layer, but the resistance change rate is also reduced.

On the other hand, as illustrated in FIG. 5, in the case where, as in the read device according to example 1, the insulating layer is constituted by the high band gap insulating layers which are formed of the magnesium oxide and each of which is formed in a portion in contact with each of the magnetic layers, and by the low band gap insulating layer which is formed of the rock salt crystal type zinc oxide and which is formed between the high band gap insulating layers, the parallel coupling RApc and the anti-parallel coupling RAapc, which represent the area resistance, become 0.07 [Ωμm²] and 1.0 [Ωμm²], respectively, and a resistance change rate becomes 1300 [%]. That is, the area resistance can be reduced as compared with the case where the magnesium oxide or the rock salt crystal type zinc oxide is used as the insulating layer, and the resistance change rate can be increased.

As described above, according to example 1, it is possible to obtain the effect of reducing the device resistance of the read device. As a result that the device resistance can be reduced, a minute change in the magnetic field can also be sensed, so that it is possible to obtain the effect of further improving the sensing ability to accurately read magnetic bits recorded in high density.

Further, according to example 1, because the device resistance can be reduced, the thickness of the insulating material can be increased, so that it is possible to obtain the effect of suppressing the device resistance from being changed due to the film thickness variation in manufacturing.

In the above, example 1 is described as an embodiment for implementing the magneto resistance effect device. However, the present example may also be implemented in various different forms other than the above described example. Thus, in the following, there will be described another embodiment included in the present example.

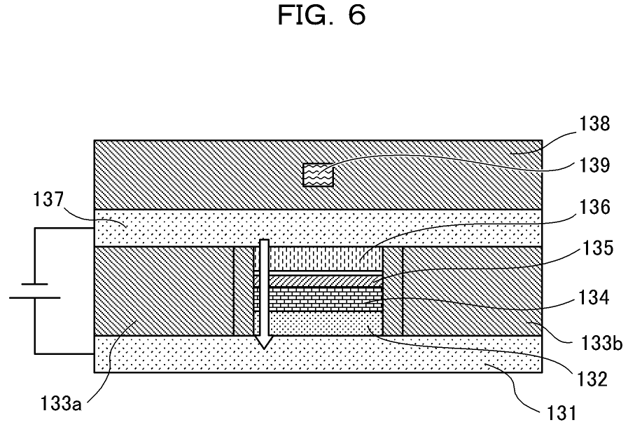

The concept of the read device described in example 1 can be similarly applied to an MRAM (Magneto resistive Random Access Memory). For example, as illustrated in FIG. 6, a read device includes non-magnetic layers 131 and 137, side insulating layers 133a and 133b, an antiferromagnetic layer 132, a side insulating layer, a fixed layer(a soft magnetic layer) 134, an insulating layer(a insulator) 135, a recording layer 136, and an insulating layer 138. The read device includes the recording layer 136 instead of the free layer (see FIG. 2), and is configured so that the magnetization of the recording layer 136 is controlled by the magnetic field generated by a current made to flow through a recording current layer 139. The parallel state or the anti-parallel state of the magnetization direction set with respect to the fixed layer 134 corresponds to the on-state or the off-state of the record bit. When a sense current is made to flow in the vertical direction, it is possible to obtain a resistance change based on the magneto resistance effect in correspondence with the magnetization direction.

Further, the read device described in the example 1 can also be applied to the head slider configured to perform magnetic recording to a magnetic recording medium.

These result in the effect that it is possible to obtain a head slider and an MRAM, in each of which the sensing ability of the read device is further improved.

The read device illustrated in FIG. 2 need not be physically constituted as illustrated in the figure. That is, the thickness, and the like, of each of the metal oxide layers constituting the TMR film of the read device may be suitably changed within the object of the present example.

The present example has the effect that it is possible to realize reduction in resistance of a magneto resistance effect device, such as a read device.

Further, the present example has the effect that it is possible to suppress the device resistance from being changed due to the film thickness variation in manufacturing.

Further, the present example has the effect that it is possible to obtain a head slider, a magnetic information storage apparatus, and a magneto resistance effect memory, in each of which the sensing ability of the read device is further improved.

As described above, the magneto resistance effect device, the head slider, the magnetic information storage apparatus, and the magneto resistance effect memory, according to the present example, are useful for sensing a small change in a magnetic field emanating from a record bit recorded in a magnetic recording medium, so as to thereby read the magnetic bits recorded in high density, and are particularly suitable for realizing reduction in the device resistance.

All examples and conditional language recited herein are intended for pedagogical purposes to aid the reader in understanding the invention and the concepts contributed by the inventor to furthering the art, and are to be constructed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A magneto resistance effect device comprising:
a fixed magnetization portion including a ferromagnetic material, and in which the magnetization direction can be fixed;
a tunnel barrier layer including high band gap metal oxide and low band gap metal oxide, and the tunnel barrier layer arranged on the fixed magnetization portion; and
a free magnetization portion including a ferromagnetic material, arranged on the tunnel barrier layer, and in which the magnetization direction can be changed.

2. The magneto resistance effect device according to claim 1, wherein the tunnel barrier layer comprises:
at least two high band gap layers including the high band gap metal oxide, and two of which are in contact with the fixed magnetization portion and the free magnetization portion respectively; and
at least one low band gap layer including low band gap metal oxide, and arranged between the high band gap layers.

3. The magneto resistance effect device according to claim 1,
wherein the high band gap metal oxide includes magnesium oxide, and the low band gap metal oxide includes at least one of zinc oxide and cadmium oxide.

4. The magneto resistance effect device according to claim 2,
wherein the high band gap metal oxide includes magnesium oxide, and the low band gap metal oxide includes at least one of zinc oxide and cadmium oxide.

5. A head slider configured to read or write data in a magnetic recording medium, comprising:
a fixed magnetization portion including a ferromagnetic material, and in which the magnetization direction can be fixed;
a tunnel barrier layer including high band gap metal oxide and low band gap metal oxide, and arranged on the fixed magnetization portion;
a free magnetization portion including a ferromagnetic material, arranged on the tunnel barrier layer, and in which the magnetization direction can be changed; and
a magnetic writing portion performing magnetic recording to the magnetic recording medium.

6. The head slider according to claim 5, wherein the tunnel barrier layer comprises:
at least two high band gap layers including the high band gap metal oxide, and two of which are in contact with the fixed magnetization portion and the free magnetization portion respectively; and
at least one low band gap layer including low band gap metal oxide, and arranged between the high band gap layers.

7. The head slider according to claim 5, wherein the high band gap metal oxide includes magnesium oxide, and the low band gap metal oxide includes at least one of zinc oxide and cadmium oxide.

8. The head slider according to claim 6, wherein the high band gap metal oxide includes magnesium oxide, and the low band gap metal oxide includes at least one of zinc oxide and cadmium oxide.

9. A magnetic information storage apparatus configured to read data from a magnetic recording medium using a head, the head comprising:
a fixed magnetization portion including a ferromagnetic material, and in which the magnetization direction can be fixed;
a tunnel barrier layer including high band gap metal oxide and low band gap metal oxide, and arranged on the fixed magnetization portion; and
a free magnetization portion including a ferromagnetic material, arranged on the tunnel barrier layer, and in which the magnetization direction can be changed,
wherein the data is read from the magnetic recording medium in such a manner that a voltage is applied between the fixed magnetization portion and the free magnetization portion and the magnetization direction in the free magnetization portion is changed by a magnetic field generated by the magnetic recording medium.

10. The magnetic information storage apparatus according to claim 9, wherein the tunnel barrier layer comprises:
high band gap layers including the high band gap metal oxide, and two of which are in contact with the fixed magnetization portion and the free magnetization portion respectively; and
a low band gap layer including low band gap metal oxide, and arranged between the high band gap layers.

11. The magnetic information storage apparatus according to claim 9,
wherein the high band gap metal oxide includes magnesium oxide, and the low band gap metal oxide includes at least one of zinc oxide and cadmium oxide.

12. The magnetic information storage apparatus according to claim 10,
wherein the high band gap metal oxide includes magnesium oxide, and the low band gap metal oxide includes at least one of zinc oxide and cadmium oxide.

13. A magneto resistance effect memory comprising:
a fixed magnetization portion including a ferromagnetic material, and in which the magnetization direction can be fixed;
a tunnel barrier layer including high band gap metal oxide and low band gap metal oxide, and arranged on the fixed magnetization portion; and
a free magnetization portion including a ferromagnetic material, arranged on the tunnel barrier layer, and in which the magnetization direction can be changed, and data is stored depending on the magnetization direction.

14. The magneto resistance effect memory according to claim 13, wherein the tunnel barrier layer comprises:
high band gap layers including the high band gap metal oxide, and two of which are in contact with the fixed magnetization portion and the free magnetization portion respectively; and
a low band gap layer including low band gap metal oxide, and arranged between the high band gap layers.

15. The magneto resistance effect memory according to claim 13,
wherein the high band gap metal oxide includes magnesium oxide, and the low band gap metal oxide includes at least one of zinc oxide and cadmium oxide.

16. The magneto resistance effect memory according to claim 14,
wherein the high band gap metal oxide includes magnesium oxide, and the low band gap metal oxide includes at least one of zinc oxide and cadmium oxide.
